(19) United States
(12) Patent Application Publication
(10) Pub. No.: US 2016/0130925 A1
(43) Pub. Date: May 12, 2016

(54) In-Situ Conversion Process for Oil Shale

(71) Applicant: HALLIBURTON ENERGY SERVICES, INC., Houston, TX (US)

(72) Inventors: Pubudu H. Gamage, Katy, TX (US); Ali Alwattari, Humble, TX (US); Philip D. Nguyen, Houston, TX (US)

(73) Assignee: Halliburton Energy Services, Inc., Houston, TX (US)

(21) Appl. No.: 14/903,216

(22) PCT Filed: Aug. 26, 2013
(86) PCT No.: PCT/US2013/056643

§ 371 Date: Jan. 6, 2016

(51) Int. Cl. E21B 43/24; C09K 8/592

(52) U.S. Cl. CPC E21B 43/24; E21B 43/2405; C09K 8/592; C09K 2208/10

(57) ABSTRACT

Systems and methods for oil recovery from oil shale are described. Systems and methods may include a method for in-situ conversion of oil shale. The method may include providing one or more magnetic probes within an oil shale formation; providing magnetic nanoparticles into the oils shale formation; and alternating the magnetic field of the one or more magnetic probes to heat the oil shale formation. A system for in-situ conversion of oil shale may include one or more magnetic probes within an oil shale formation and magnetic nanoparticles within the oils shale formation. A magnetic field may be applied by the one or more magnetic probes to the magnetic nanoparticles to heat the oil shale formation. A composition for a fracture fluid may include a fracturing fluid and magnetic nanoparticles.

### FIELD

The present disclosure relates to systems and methods for processing hydrocarbons, and, more specifically, to systems and methods for in-situ or similar conversion of hydrocarbons, such as oil shale.

### BACKGROUND

Shale is considered a significant alternative source of oil, but the cost of extraction is typically higher than other oil sources. As the price of oil increases, extraction of oil from shale will become more economically viable.

World total shale oil reserves are estimated at approximately 2,826 billion barrels. About 52% (approximately 1,446 billion barrels) of that total world shale oil reserves are located in the Green River Formation. This is more than three times Saudi Arabia's proven oil reserves. The Green River Formation is located across Colorado, Utah and Wisconsin in the United States of America, and is considered one of the largest known oil shale formations in the world.

Hydrocarbons in the Green River Formation are mainly kerogen, which cannot be economically extracted using conventional technology. Commercial oil production has been attempted in the Green River Formation for the last 100 years, especially during periods of higher oil prices. In one process, an in-situ conversion process (ICP) cracks kerogen into lighter oils using tightly spaced electric heaters that heat the formation for long periods of time, typically about 3-6 years. This process, however, is not commercially viable due to high costs of operation and extraction.

### BRIEF DESCRIPTION OF THE DRAWINGS

The accompanying drawings, which are included to provide a further understanding of the disclosure and are incorporated in and constitute a part of this specification, illustrate preferred embodiments of the disclosure and together with the detailed description serve to explain the principles of the disclosure. In the drawings:

FIG. 1 is a schematic diagram of an exemplary in-situ conversion process using magnetic nanoparticles and alternating magnetic fields.

### DETAILED DESCRIPTION OF THE PREFERRED EMBODIMENTS

Systems and methods are described for extraction of oil from shale formation. In certain embodiments, processes may be used to extract oil from Green River Formation shale or other shale formations that have large concentrations of heavier hydrocarbons, such as kerogen, by cracking them in-situ into lighter hydrocarbons prior to extraction. In certain embodiments, the systems and methods described herein may be used for recovery of heavy oil by decreasing viscosity to a lower recoverable viscosity. The examples described herein relate to the Green River Formation for illustrative purposes only. In particular, the systems and methods may be used wherever cracking of heavier hydrocarbons is desirable. Embodiments may be used with, for example, tar sands as well. Lower nanoparticle concentration and/or lower magnetic field may be used in such applications as lower heat is generally needed to decrease the density of heavy oil, compared to the heat needed for cracking. Any oil and gas production enhancement facility and/or transportation system where viscosity reduction may benefit from use of the embodiments described herein. Embodiments may allow for improved pumping, spreading, chemical synthesis reactions to produce higher value intermediaries and/or end products. Embodiments may be used in any type of subsurface application that requires heat, or for non-underground uses, such as heating of reactor vessels, where appropriate.

As disclosed in exemplary embodiments herein, magnetic nanoparticles may be utilized to generate heat for long time periods, which may in turn generate hydrocarbons by in-situ conversion process (ICP) technology. Magnetic nanoparticles may be incorporated into fracture fluids and injected into a formation, such as a shale formation. In certain embodiments, the magnetic nanoparticles may be added to fracture fluid formulations and delivered into target zones, such as a kerogen zone, through fractures or existing pores. The downhole contacting of the fracture fluids with the subterranean formation can be any suitable contacting. In some examples, the contacting can include contacting subterranean material that is in or proximate to a production zone. In some examples, the method of treating the subterranean formation may be a method of fracking, depositing proppant, curing resin, or any combination thereof.

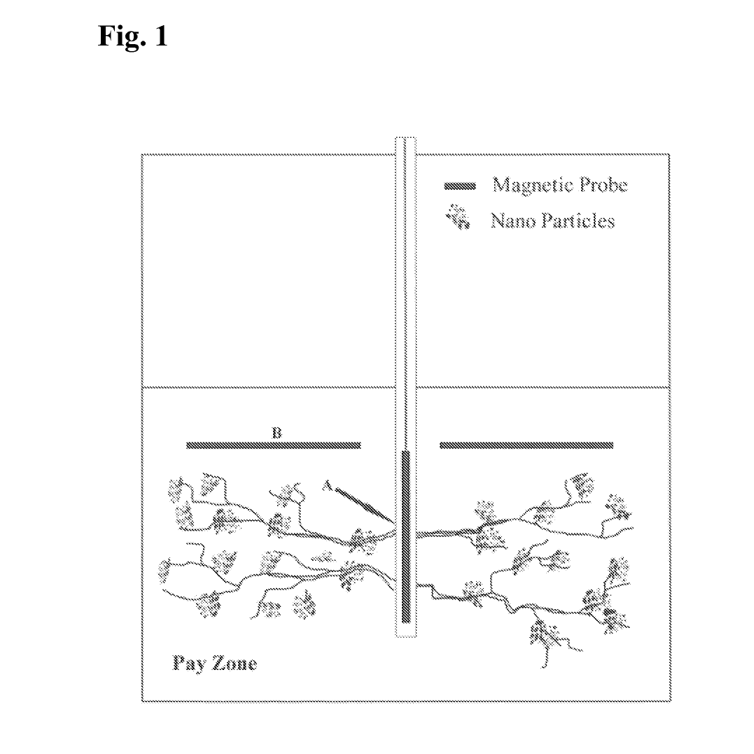

FIG. 1 is a schematic diagram of an exemplary in-situ conversion process using magnetic nanoparticles and alternating magnetic field. One or more magnetic probes (A and B) may be positioned within a formation. The one or more magnetic probes may be located in a wellbore and/or at different depths. The one or more magnetic probes may be spaced at a distance of approximately 2 m to approximately 6 m, more preferably 3 m to approximately 5 m. The one or more magnetic probes may be oriented relative to the wellbore in parallel and/or perpendicular directions. In certain embodiments, the one or more magnetic probes may be oriented relative to the wellbore in an oblique direction and/or a non-linear orientation. The one or more magnetic probes may be oriented relative to one another in parallel directions. In certain embodiments, however, the one or more magnetic probes may be oriented relative to one another in perpendicular, oblique and/or in a non-linear orientation. Magnetic field may be generated between magnetic probes that have been placed inside a main wellbore and/or inside one or more multi-lateral wellbores extending from the main wellbore. The timing and patterns of activation may vary. In general, having all probes active at the same time may generate more heat, which may help to improve the efficiency of the in-situ conversion process.

A fracture fluid containing magnetic nanoparticles may be provided to the formation. The magnetic nanoparticles may be provided to the formation as a compacted pill or pressed tablet. In certain embodiments, the magnetic nanoparticles may be dry blended with proppants or precipitated from solution into solid deposits by a pH and/or chemical additive and/or surfactant in a secondary addition to the fracturing fluid during pumping or downhole. Alternatively, magnetic nanoparticles may be coated onto the proppant and placed inside the fractures located within a subterranean formation as part of the hydraulic fracturing treatment.

### Magnetorheological Fluids

Magnetorheological (MR) fluids are fluids that change apparent viscosity in response to a magnetic field. MR fluids may include a suspension of magnetizable particles in a carrier liquid or fluid. In some examples, the MR fluid can go from the consistency of a liquid to that of a solid, semi-solid, or gel with a response time on the order of milliseconds. In some examples, the magnetizable particles and the carrier liquid can be any substantially magnetizable particles and carrier liquid, such that the fluid exhibits a change in apparent viscosity or yield shear strength in response to an electric field. The MR fluid can include any suitable additional material. In some examples, the MR fluid may include anti-settling agents that aid in keeping the magnetizable particles suspended in the carrier liquid, such as thixotropic agents, surfactants, dispersants, thickeners, rheology modifiers, or anti-wear agents.

In various examples, the magnetizable particles can include any magnetizable solid material, such as paramagnetic, superparamagnetic, ferrimagnetic, and ferromagnetic materials. Examples of magnetizable materials may include pure metals, metal alloys, metal compounds, and any magnetically soft material. Additional examples of magnetizable materials can include iron; nickel; cobalt; alloys of Fe, Ni, or Co; iron oxide; gamma iron oxide; iron cobalt alloys, iron nickel alloys, iron silicon alloys, iron carbide, steel of carbon content lower than 1%, alloys of iron with aluminum, silicon, cobalt, nickel, vanadium, molybdenum, chromium, tungsten and manganesevarious ferrites, including ferrites of Co, Fe, Mg, Mn, Ni or Zn, or combinations thereof, manganese zinc ferrites and zinc nickel ferrites; chrome oxide, iron nitride; vanadium alloys, tungsten alloys, copper alloys, manganese alloys; magnetic oxides of chromium and iron, such as chromium dioxide, gamma-Fe₂O₃ and Fe₃O₄; any other suitable magnetizable material; and combinations thereof. In various examples, the magnetizable particles can have an average diameter of about 0.001-10,000 μm, 0.01-1000 μm, 0.1-100 μm, and/or about 1-20 μm. In various examples, the size distribution of the magnetizable particles can be monomodal; in other examples, the size distribution of the magnetizable particles can be bimodal or polymodal, with each average diameter of each grouping of particle sizes being between about 0.001-10,000 μm and being present in any suitable proportion. In various embodiments, the magnetizable particles can be about 0.1-99.9 wt %, 10-95 wt %, 25-90 wt %, or about 50-90 wt % of the MR fluid.

In various examples, the carrier liquid can be a mineral oil, a hydrocarbon oil, water, a silicone oil, an esterified fatty acid, an organic liquid, a solvent, or a combination thereof. In some examples, the carrier liquid can have a viscosity of about 0.01 to 100,000 cP, 0.1 to 10,000 cP, 1 to 1000 cP, or about 10 to 200 cP, measured at about room temperature. In some examples, the MR fluid with no exposure to a magnetic field can have a viscosity substantially the same as the viscosity of the magnetically insulating fluid. In some examples, the carrier liquid can be about 0.1-99.9 wt %, 0.5-80 wt %, 1-50 wt %, 10-50 wt %, or about 1-20 wt % of the MR fluid.

In some examples, the MR fluid can include a surfactant to aid in keeping the magnetizable particles suspended in the carrier liquid. The surfactant can be any suitable surfactant, for example, oleic acid, tetramethylammonium hydroxide, citric acid, soy lecithin, or a combination thereof. In some examples, at least some of the magnetizable particles can be coated by surfactant. The surfactant can be present in any suitable amount, such as less than about 1 wt % of the MR fluid, or less than about 0.1 wt % of the MR fluid.

In some examples, the MR fluid can include a thixotropic agent to aid in keeping the magnetizable particles suspended in the carrier liquid. In some examples, the thixotropic agent is fumed or precipitated silica. The thixotropic agent can be present in any suitable amount, such as less than about 10 wt % of the MR fluid, less than about 1 wt %, or less than about 0.1 wt % of the MR fluid.

In some examples, the MR fluid can further include suspended particles of an organic polymeric material that can enhance the MR properties of the MR fluid, such as a polymerized alkene-containing compound such as polystyrene. In some examples, the suspended particles of organic polymeric material can have an average diameter of about 0.01-1000 μm, or about 1-500 μm. In some examples, the MR fluid can include about 1-75 wt %, 5-50 wt %, or about 5-30 wt % of the suspended particles of the organic material.

In various examples, the MR fluid can experience a change in yield shear strength upon exposure to a magnetic field of about 0.01 kA/m-100,000 kA/m, 0.1 kA/m-1,000 kA/m, or about 1 kA/m-1000 kA/m. In various examples, the average change in yield shear strength or viscosity per change in the magnetic field can be approximately linear, non-linear, or a combination thereof. In some embodiments, the average change in yield shear strength or viscosity is approached, at which point the relationship can become non-linear; in other embodiments, the relationship can be approximately linear or non-linear throughout. In some examples, the average change in viscosity per change in the magnetic field can be about 0.001-1,000,000 cP per 1 kA/m, or about 0.1-100,000 cP per 1 kA/m, or about 1-1000 cP per 1 kA/m. In some examples, the average change in yield shear strength per change in the magnetic field can be about 0.001-1,000,000 Pa per 1 kA/m, or about 0.1-100,000 Pa per 1 kA/m, or about 1-1000 Pa per 1 kA/m, or about 50-600 Pa per 1 kA/m. In some embodiments, the MR fluid can have a maximum yield shear strength or viscosity; in other embodiments, the MR fluid can have no maximum yield shear strength or viscosity. In various embodiments, the MR fluid can have a maximum yield shear strength of about 0.001 kPa, 0.01 kPa, 0.1 kPa, 1 kPa, 2 kPa, 3 kPa, 4 kPa, 5 kPa, 10 kPa, 20 kPa, 30 kPa, 40 kPa, 50 kPa, 75 kPa, 100 kPa, 150 kPa, 200 kPa, 300 kPa, 400 kPa, 500 kPa, 750 kPa, 1000 kPa, 10,000 kPa, 100,000 kPa, or about 1,000,000 kPa or more. In various embodiments, the MR fluid can have a maximum viscosity at about room temperature of about 0.01 cP, 0.1 cP, 1 cP, 5 cP, 10 cP, 15 cP, 20 cP, 50 cP, 100 cP, 200 cP, 500 cP, 1000 cP, 5000 cP, 10,000 cP, 50,000 cP, 100,000 cP, 500,000 cP, 1,000,000 cP, 10,000,000 cP, 100,000,000 cP, 500,000,000 cP, or about 1,000,000,000 cP or more.

An alternating magnetic field may be applied by the one or more magnetic probes. The magnetic field is alternated at a rate of approximately 50 kHz to approximately 10 MHz. The magnetic field has a strength of approximately 10 mT to approximately 250 mT. The magnetic field may penetrate a formation to a depth of approximately 2 m to approximately 10 m. In various examples, the current applied to the electromagnet generates a magnetic field at the location where the viscosity, yield shear strength, or combination thereof of the fluid is altered by any suitable strength, such as about 0.01 kA/m-100,000 kA/m, 0.1 kA/m-1,000 kA/m, or about 1 kA/m-1000 kA/m.

Magnetic nanoparticles can be induced to produce heat when subject to an alternating magnetic field. This heat may in turn be used to heat the formation. The initial temperature of a formation may be, for example, approximately 32° F. to approximately 250° F. A fracture fluid may be introduced at a temperature of approximately 70° F. to approximately 450° F. The temperature of the formation may initially drop after introduction of the fracture fluid to approximately 100° F. The temperature of the oil shale formation may be increased by approximately −200° F. to approximately 600° F., or by approximately 300° F. to approximately 400° F. The heating using the in-situ conversion process may raise the temperature of the formation to a predetermined temperature of approximately 500° F. to approximately 750° F. Time to raise the temperature to the predetermined temperature may be approximately 1 hour to approximately 1 month. The in-situ conversion process may be operated at the predetermined temperature for approximately 2 years to approximately 7 years. Generated heat may be utilized in thermal cracking of kerogen or other heavy hydrocarbons into low molecular weight hydrocarbons, gas and/or water molecules. Shale oil produced by the in-situ conversion process may result in lighter crude oils, such as 25-40° API or heavier crude oils, such as 20° API or less. Hydrocarbons created by the in-situ conversion process may be produced by conventional methodology. Primary production may utilize the reservoir pressure and increase in pressure due to the fluid expansion. The hydraulic fracturing can be used to increase communication in the reservoir. Gas injection is another method that can be utilize in pressure maintenance during the oil production.

In certain embodiments, the formation may contain primarily kerogen in addition to inorganic material, such as the Green River Formation. Kerogen may be converted into bitumen and lighter oils by heating. Oil types may be determined by API gravity and viscosity. API gravities and approximate viscosity values for different types of oils are listed below in Table 1.

TABLE 1

| Oil Type | API Gravity | Viscosity (cp) |
|---|---|---|
| Extra heavy oil | Less than 10° | Over 10000 |
| Heavy Oil | 10-20° | 100-10000 |
| Light oil | Over 40° | 10-25 |

Exemplary compositions for fracture fluids are also described herein. The exemplary fracture fluids may incorporate magnetic nanoparticles with a fracture fluid base. An exemplary formulation may include one or more of a fracturing fluid base, a proppant, a thickener, a crosslinker, a pH adjusting compound, and a breaker.

Magnetic nanoparticles may be added to the fracture fluid formulation. The magnetic nanoparticles may be one or more of iron (II,III) oxide (Fe₃O₄), magnetic cores including metals (for example, but not limited to, nickel, cobalt and neogymium-iron-boron), and others. The nanoparticles may have a concentration of approximately 0.1 lb/bbl to approximately 100 lb/bbl, more preferably a concentration of approximately 0.15 lb/bbl to approximately 50 lb/bbl and most preferably a concentration of approximately 0.2 lb/bbl to approximately 10 lb/bbl. To aid in suspension of the magnetic nanoparticles, the magnetic nanoparticles may have a specific gravity of approximately 0.8-1.2.

The fracture fluid ingredients may be compatible with the magnetic nanoparticles and vice versa. For example, it may be desirable that the magnetic nanoparticles do not react with metallic or other crosslinkers. The magnetic nanoparticles should also be processed in a way to maintain a desired nano-size dispersion. For example, a dispersing agent may be used, and/or the formulation may be slow mixed at the beginning or end of a batch process, and/or magnetic nanoparticles may be added on the fly during the job to create a desired nano-size dispersion. To determine desirable nanoparticles, a fixed percentage or approximately 0.1-30% magnetic nanoparticles may be added to a fracturing fluid, such as a standard water plus gel fluid. An electric field applied while in a magnetic strength measuring tester or chamber may allow for rank ordering performance responses of different sizes and chemistries of the nanoparticles.

Embodiments may produce hydrocarbons that are more profitable than the original hydrocarbons, and may have a lower environmental impact than ex-situ recovery techniques, particularly for the Green River Formation. Higher oil prices and higher demand for oil may make this type of technology more commercially viable. Increasing oil production from unconventional resources may also foster energy independence. Embodiments may also be used to recover heavy oil by decreasing the viscosity of bitumen to a lower recoverable viscosity. Because some embodiments may have a permanent magnetic moment or quality, some of the nanoparticles can be recovered from the well using the nanoparticles' magnetic properties. In certain embodiments, the magnetic nanoparticles may assist the fracking ability of the combined composition. Certain sized particles may attach to and harden proppant to resist fracture reclosure, for example.

The in-situ conversion process described herein may be used in combination with other recovery processes. Magnetic nanoparticles may have additional functionality. Additional functionalities may include, but are not limited to, catalytic functionality, increasing yield strength, increasing suspension ability (gel strength) for proppant holdings, and/or delaying sinking of proppant in a fracture zone.

All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

Although the foregoing description is directed to the preferred embodiments of the disclosure, it is noted that other variations and modifications will be apparent to those skilled in the art, and may be made without departing from the spirit or scope of the disclosure. Moreover, features described in connection with one embodiment of the disclosure may be used in conjunction with other embodiments, even if not explicitly stated above.

What is claimed is:

1. A method for in-situ conversion of oil shale, the method comprising:
providing one or more magnetic probes within an oil shale formation;
providing magnetic nanoparticles into the oils shale formation; and
alternating the magnetic field of the one or more magnetic probes to heat the oil shale formation via the magnetic nanoparticles.

2. The method of claim 1, wherein the oil shale formation comprises kerogen.

3. The method of claim 2, wherein the kerogen is converted into bitumen and lighter oil.

4. The method of claim 1, wherein the one or more magnetic probes are spaced at a distance of approximately 2 m to approximately 6 m.

5. The method of claim 1, wherein the one or more magnetic probes are oriented parallel or perpendicular to the wellbore.

6. The method of claim 1, wherein the magnetic nanoparticles are selected from the group consisting of: iron (II)(III) oxide, nickel core particles, cobalt core particles, neogymium-iron-boron particles, and combinations thereof.

7. The method of claim 1, wherein the magnetic nanoparticles are provided with a fracture fluid.

8. The method of claim 7, wherein the magnetic nanoparticles are provided at a concentration of approximately 0.2 lb/bbl to approximately 50 lb/bbl in the fracture fluid.

9. The method of claim 1, wherein the magnetic field is alternated at a rate of approximately 50 kHz to approximately 10 MHz.

10. The method of claim 1, wherein the magnetic field has a strength of approximately 10 mT to approximately 250 mT.

11. The method of claim 1, wherein the temperature of the oil shale formation is increased by approximately −200° F. to approximately 600° F.

12. The method of claim 1, wherein the process is operated for approximately 2 years to approximately 7 years.

13. The method of claim 1, wherein the method produces bitumen and lighter oil, and the bitumen and lighter oil is produced by conventional production methods.

14. A system for in-situ conversion of oil shale, the system comprising:
one or more magnetic probes within an oil shale formation;
magnetic nanoparticles within the oils shale formation; and
wherein a magnetic field is applied by the one or more magnetic probes to the magnetic nanoparticles to heat the oil shale formation.

15. The method of claim 14, wherein the one or more magnetic probes are spaced at a distance of approximately 2 m to approximately 6 m.

16. The method of claim 1, wherein the one or more magnetic probes are oriented parallel or perpendicular to the wellbore.

17. The system of claim 14, wherein the magnetic field is alternated at a rate of approximately 50 kHz to approximately 10 MHz, and has a strength of approximately 10 mT to approximately 250 mT.

18. The system of claim 14, wherein the magnetic nanoparticles are selected from the group consisting of: iron (II)(III) oxide, nickel core particles, cobalt core particles, neogymium-iron-boron particles, and combinations thereof.

19. The system of claim 14, wherein the magnetic nanoparticles are provided with a fracture fluid.

20. The system of claim 19, wherein the magnetic nanoparticles are provided at a concentration of approximately 0.2 lb/bbl to approximately 50 lb/bbl in the fracture fluid.
